(19) United States
(12) Patent Application Publication
(10) Pub. No.: US 2024/0283662 A1
(43) Pub. Date: Aug. 22, 2024

(54) INFORMATION PROCESSING APPARATUS, CONTROL METHOD THEREFOR, AND NON-TRANSITORY COMPUTER-READABLE STORAGE MEDIUM STORING PROGRAM

(71) Applicant: CANON KABUSHIKI KAISHA, Tokyo (JP)

(72) Inventor: TAKUYA HATAKEYAMA, Kanagawa (JP)

(21) Appl. No.: 18/436,437

(22) Filed: Feb. 8, 2024

(30) Foreign Application Priority Data
Feb. 17, 2023 (JP) 2023-023635
Jan. 31, 2024 (JP) 2024-013310

(51) Int. Cl. H04L 9/32

(52) U.S. Cl. CPC H04L 9/3268

(57) ABSTRACT

An information processing apparatus includes at least one memory and at least one processor which function as: a first acquisition unit configured to acquire a first root certificate for executing encrypted communication with a first server from the first server; a second acquisition unit configured to acquire, via encrypted communication that is executable by using the first root certificate, a second root certificate for executing encrypted communication with a second server different from the first server; and a communication unit configured to communicate with the second server via encrypted communication that is executable by using the second root certificate.

### BACKGROUND OF THE INVENTION

### Field of the Invention

The present invention relates to an information processing apparatus, a control method therefor, and a non-transitory computer-readable storage medium storing a program.

### Description of the Related Art

An information processing apparatus such as a printer, a digital still camera, and a portable music player has a function of connecting the apparatus itself to the Internet. Therefore, to ensure security of the apparatus to cope with encrypted communication such as Secure Socket Layer (SSL) communication, it is required to install, on such information processing apparatus, an electronic certificate that is conventionally for a computer.

The electronic certificate is used to, for example, verify authenticity of an electronic signature or the like, and is generally issued from a trusted third party certification body (to be referred to as a certificate authority hereinafter). By using the issued electronic certificate, for example, it is possible to prove that a server to be accessed can perform encrypted communication and to prove that a provider of a Web site actually exists.

In addition, the electronic certificate includes a so-called root certificate that is signed and issued by a certificate authority to verify authenticity of the certificate. Normally, when performing encrypted communication, a Web browser, a network controller, or the like holds a root certificate issued in advance by the certificate authority. Then, when performing communication with a Web site (Web server), it is checked whether a server certificate transmitted from the Web site (Web server) is authentic. When the authenticity of the server certificate is checked, it is determined first whether the server certificate issued by the certificate authority is authentic. Then, if the server certificate is authentic, it is checked whether the certificate authority itself can be trusted. At this time, if the user holds, in advance, a root certificate electronically signed by the certificate authority, the Web site (Web server) can be regarded to be trusted. Note that the root certificate or the server certificate normally has an expiration period. Therefore, there is provided a technique for performing an update operation of such certificate (see Japanese Patent Laid-Open No. 2006-239930).

Furthermore, there is provided a technique of providing root certificate data to firmware of the update version and updating the root certificate together with update of the firmware (see Japanese Patent Laid-Open No. 2008-129788).

### SUMMARY OF THE INVENTION

The present invention provides a technique of making it possible to acquire a root certificate from an external apparatus even in a network environment where communication that is not encrypted communication is not permitted.

The present invention in one aspect provides an information processing apparatus includes at least one memory and at least one processor which function as: a first acquisition unit configured to acquire a first root certificate for executing encrypted communication with a first server from the first server; a second acquisition unit configured to acquire, via encrypted communication that is executable by using the first root certificate, a second root certificate for executing encrypted communication with a second server different from the first server; and a communication unit configured to communicate with the second server via encrypted communication that is executable by using the second root certificate.

According to the present invention, it is possible to acquire updated electronic certificate data from an external apparatus by encrypted communication and perform update processing. Therefore, according to an effect, it is possible to acquire a root certificate from a server even in a network environment where communication that is not encrypted communication is not permitted.

Further features of the present invention will become apparent from the following description of exemplary embodiments with reference to the attached drawings.

### BRIEF DESCRIPTION OF THE DRAWINGS

FIG. 1 is a block diagram for explaining the hardware arrangement of an information processing apparatus according to the first embodiment of the present invention;

FIGS. 2A and 2B are a sequence chart for explaining processing in which the information processing apparatus according to the first embodiment acquires a first root certificate group from a root certificate server;

FIGS. 3A and 3B are a sequence chart for explaining processing in which the information processing apparatus according to the first embodiment acquires a second root certificate group from the root certificate server;

FIG. 4 is a view showing the relationship among the information processing apparatus, the root certificate server, and a content server according to the first embodiment;

FIGS. 5A and 5B are views showing the data arrangements of the first root certificate group and the second root certificate group according to the first embodiment;

FIG. 6 is a view for explaining the states of root certificates held in a ROM, a RAM, and a nonvolatile memory in the information processing apparatus according to the first embodiment;

FIG. 7 is a flowchart for explaining processing in which an information processing apparatus according to the second embodiment acquires a first root certificate group from a root certificate server 112;

FIG. 8 is a flowchart for explaining processing in which an information processing apparatus according to the third embodiment acquires a first root certificate group from a root certificate server;

FIG. 9 is a view showing an example of a screen for displaying, in step S808 of FIG. 8, on an operation unit of the information processing apparatus, a fact that a root certificate has expired;

FIG. 10 is a view showing an example of a screen for displaying, in step S809 of FIG. 8, an instruction to install a root certificate using a USB memory to update a root certificate; and

FIG. 11 is a block diagram showing the hardware arrangement of a root certificate server according to an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

In a case where an information processing apparatus such as a printer, a digital still camera, or a portable music player copes with encrypted communication on the Internet, the apparatus needs to have a function of implementing acquisition and update processing of a root certificate, as described in Japanese Patent Laid-Open No. 2006-239930. However, in the technique described in Japanese Patent Laid-Open No. 2006-239930, to acquire a root certificate, it is impossible to use encrypted communication using a root certificate for communication between the information processing apparatus and a server apparatus of an acquisition source. Therefore, in a network environment where communication that is not encrypted communication is not permitted, it is impossible to perform communication between the information processing apparatus and the server apparatus of the acquisition source, and thus a root certificate cannot be acquired.

According to the present disclosure, it is possible to acquire updated electronic certificate data from an external apparatus by encrypted communication and perform update processing. Thus, it is possible to acquire a root certificate from a server even in a network environment where communication that is not encrypted communication is not permitted.

### First Embodiment

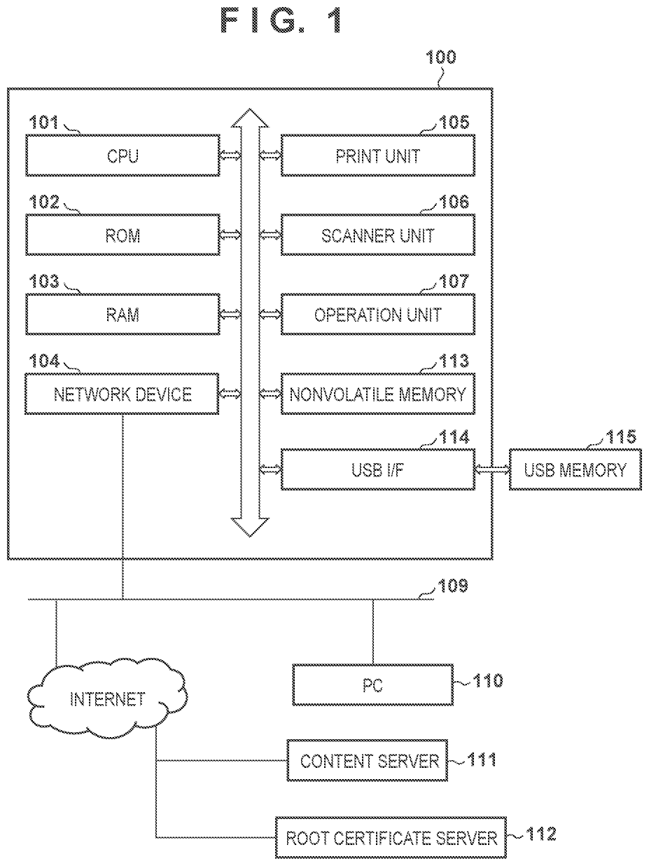

FIG. 1 is a block diagram for explaining, as an embodiment of a printer apparatus, the hardware arrangement of an information processing apparatus according to the first embodiment of the present invention.

In an information processing apparatus 100, a CPU 101 deploys control programs stored in a Read Only Memory (ROM) 102 in a RAM 103 and executes them, thereby executing various processes for controlling the operation of the information processing apparatus 100. The ROM 102 stores control programs and the like. The RAM 103 is used as a main memory of the CPU 101, a temporary memory area such as a work area, and a deployment area of a program. The information processing apparatus 100 of the embodiment is configured so that one CPU 101 executes each process in a flowchart (to be described later) but may have another form. For example, a plurality of CPUs may be able to execute each process in the flowchart (to be described later) in cooperation with each other. Furthermore, some of the processes of the flowchart (to be described later) may be executed using a hardware circuit such as an ASIC.

A print unit 105 executes print processing on a print medium (a printing medium such as a sheet or paper) based on print data received by a network device 104. A scanner unit 106 reads a document placed by the user to generate a document image (scan image). The document image generated by the scanner unit 106 is printed by the print unit 105 (copy processing), or saved in a PC 110 via a network 109.

An operation unit 107 includes various hardware keys and a display (display unit) having a touch panel function, and the display of the operation unit 107 displays various operation screens. The user can input an instruction or information to the information processing apparatus 100 via the operation unit 107. The network device 104 is connected to the network 109 via a LAN cable, and communicates with a communication apparatus existing on the network 109, in this example, a host terminal such as the PC 110. An encrypted communication protocol such as the Transport Layer Security (TLS) protocol is applied to communication executed by the network device 104. The above-described units such as the CPU 101, the ROM 102, and the RAM 103 are connected to a bus 108, and control signals and data signals from the CPU 101 are transmitted/received between the units.

A content server 111 is a server apparatus storing digital contents. The information processing apparatus 100 can acquire image data from the content server 111, and execute print processing based on the image data. However, the role of the content server 111 and data communicated between the information processing apparatus 100 and the content server 111 are not limited to them. The content server 111 may have any role as long as it serves as a server that is a communication partner of the information processing apparatus 100. Furthermore, the data communicated between the information processing apparatus 100 and the content server 111 may be any data. A root certificate server 112 is a server apparatus that holds a root certificate. The information processing apparatus 100 acquires an updated new root certificate from the root certificate server 112. Note that in this embodiment, the updated root certificate is a root certificate of a version newer than that of the root certificate stored in the memory of the information processing apparatus 100. Alternatively, the updated root certificate is a root certificate that is not expired. Furthermore, the root certificate before the update is a root certificate stored in the memory of the information processing apparatus 100, and is a root certificate of a version older than the newest version of the root certificate held in the root certificate server 112. Alternatively, the root certificate before the update is an expired root certificate.

In addition, a nonvolatile memory 113 is connected to the bus 108, and is used as a save area for storing the updated new root certificate. A USB I/F (USB interface) 114 is also connected to the bus 108. The USB I/F 114 is a USB interface for connecting a USB memory (external memory) 115 to the information processing apparatus 100.

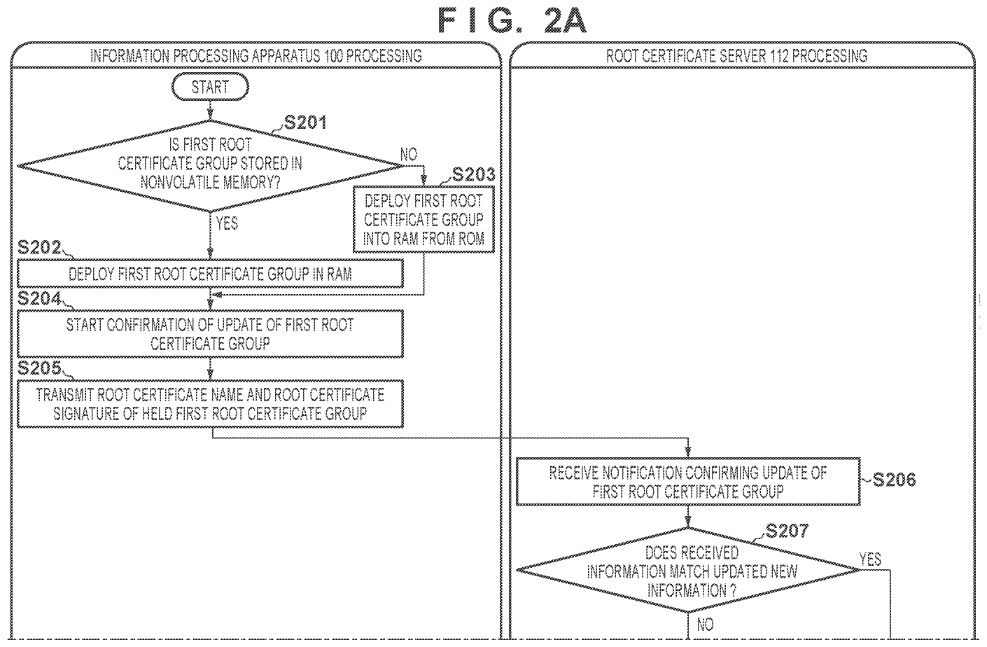

FIG. 2A and 2B are a sequence chart for explaining processing in which the information processing apparatus 100 according to the first embodiment acquires the first root certificate group (first electronic certificate data) from the root certificate server 112. The processing of the sequence chart is started based on, for example, power-on of the information processing apparatus 100. The first root certificate group includes one root certificate used for encrypted communication with the root certificate server 112 but may include a plurality of root certificates.

In S201, the information processing apparatus 100 determines whether the first root certificate group is stored in the nonvolatile memory 113. If it is determined in S201 that the first root certificate group is stored in the nonvolatile memory 113, the process advances to S202, and the information processing apparatus 100 deploys the first root certificate group stored in the nonvolatile memory 113 in the RAM 103. Then, the process advances to S204. On the other hand, if it is determined in S201 that the first root certificate group is not stored in the nonvolatile memory 113, the process advances to S203, and the information processing apparatus 100 deploys the first root certificate group stored in the ROM 102 in the RAM 103. Then, the process advances to S204.

In S204, the information processing apparatus 100 starts confirmation of the update of the first root certificate group, and advances to S205. In S205, the information processing apparatus 100 transmits the root certificate signature and the root certificate name of the held first root certificate group data to the root certificate server 112.

Thus, in S206, the root certificate server 112 receives a notification confirming the update of the first root certificate group. Next, the process advances to S207, and the root certificate server 112 determines whether the root certificate signature and the root certificate name of the first root certificate group received from the information processing apparatus 100 match those of the updated new root certificate. This determination processing corresponds to processing of determining whether the root certificate server 112 can provide, to the information processing apparatus 100, the first root certificate group of a version newer than that of the first root certificate group held in the information processing apparatus 100. Determination that these pieces of information do not match each of corresponds to determination that the root certificate server 112 can provide, to the information processing apparatus 100, the first root certificate group of a version newer than that of the first root certificate group held in the information processing apparatus 100. Determination that the pieces of information match each other corresponds to determination that the root certificate server 112 cannot provide, to the information processing apparatus 100, the first root certificate group of a version newer than that of the first root certificate group held in the information processing apparatus 100.

If it is determined that these pieces of information do not match, it is determined that it is necessary to update the first root certificate group saved in the information processing apparatus 100, and the process advances to S208. In S208, the root certificate server 112 creates an update necessity notification of the first root certificate group, and advances to S210. On the other hand, if it is determined in S207 that the pieces of information match each other, the process advances to S209, and the root certificate server 112 determines that it is unnecessary to update the first root certificate group saved in the information processing apparatus 100, and creates an update unnecessity notification of the first root certificate group. Then, the process advances to S210. In S210, the root certificate server 112 transmits the update confirmation result created in S208 or S209 to the information processing apparatus 100.

Thus, in S211, the information processing apparatus 100 receives, from the root certificate server 112, the notification indicating whether it is necessary or unnecessary to update the first root certificate group, and determines, based on the notification, whether the first root certificate group has been updated. If it is determined that the first root certificate group has been updated, that is, it is necessary to update the first root certificate group, the process advances to S212. On the other hand, if it is determined that the first root certificate group has not been updated, the processing directly ends. In S212, the information processing apparatus 100 transmits, to the root certificate server 112, a request to acquire the first root certificate group.

Thus, in S213, the root certificate server 112 receives the request to acquire the first root certificate group, and transmits data of the updated first root certificate group to the information processing apparatus 100.

In S214, if the updated first root certificate group is received and the first root certificate group is stored in the nonvolatile memory 113, the information processing apparatus 100 stores the received first root certificate group in the nonvolatile memory 113 to overwrite and update the first root certificate group stored in the nonvolatile memory 113. Alternatively, if the first root certificate group is not stored in the nonvolatile memory 113 (the first root certificate group is stored only in the ROM 102), the information processing apparatus 100 stores the received first root certificate group in the nonvolatile memory 113. Note that in this embodiment, the first root certificate group is acquired from the root certificate server 112 by communication that is not encrypted communication. Then, this processing ends.

As described above, the information processing apparatus 100 inquires of the root certificate server 112 whether the first root certificate group held in the nonvolatile memory of itself has been updated. If the first root certificate group has been updated, the information processing apparatus 100 can acquire the updated first root certificate group from the root certificate server 112, and update the root certificate group in the nonvolatile memory.

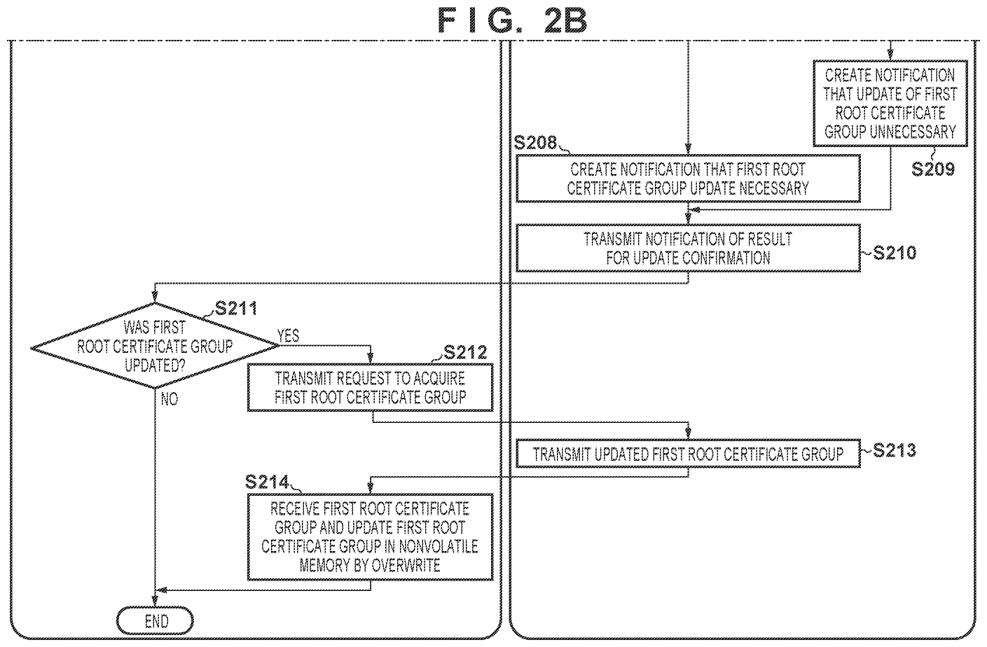

FIGS. 3A and 3B are a sequence chart for explaining processing in which the information processing apparatus 100 according to the first embodiment acquires the second root certificate group (second electronic certificate data) from the root certificate server 112. The processing of the sequence chart is started based on, for example, power-on of the information processing apparatus 100. Furthermore, the processing of the sequence chart is performed after completion of the processing described above with reference to FIGS. 2A and 2B. Note that the present invention is not limited to this, and the processing of the sequence chart may be started based on, for example, execution of a predetermined operation for starting communication with the content server 111 in the information processing apparatus 100. The second root certificate group includes a root certificate used for encrypted communication with the content server 111 but can include a plurality of root certificates in a case where there are a plurality of content servers.

In S301, the information processing apparatus 100 deploys the first root certificate group from the ROM 102 in the RAM 103. Note that at this time, if the updated first root certificate group is saved in the nonvolatile memory 113 by the processing shown in FIGS. 2A and 2B, the first root certificate group saved in the nonvolatile memory 113 is deployed in the RAM 103. Then, using the first root certificate group deployed in the RAM 103, the information processing apparatus 100 executes processing for executing encrypted communication with the root certificate server 112. More specifically, the information processing apparatus 100 first acquires a server certificate corresponding to the root certificate server 112 from the root certificate server 112. Then, the information processing apparatus 100 verifies the server certificate using the first root certificate group deployed in the RAM 103. If the server certificate is successfully verified, the information processing apparatus 100 uses a public key existing in the server certificate to generate/acquire a common key to be used for encrypted communication with the root certificate server 112. Then, the information processing apparatus 100 transmits the generated common key to the root certificate server 112. The information processing apparatus 100 communicates with the root certificate server 112 by encrypted communication using the acquired common key. That is, by executing verification processing using the first root certificate group, the information processing apparatus 100 can execute encrypted communication with the root certificate server 112. Note that communication between the information processing apparatus 100 and the root certificate server 112 executed in S303, S304, S308, S310, and S311 (to be described later) is executed by encrypted communication. Then, the information processing apparatus 100 deploys the second root certificate group from the ROM 102 into the RAM 103. Next, in S302, the information processing apparatus 100 starts confirmation of the update of the second root certificate group. After that, the process advances to S303, and the information processing apparatus 100 transmits, to the root certificate server 112, the root certificate signature and the root certificate name of the second root certificate group data held in the ROM 102 and deployed in the RAM 103.

Thus, in S304, the root certificate server 112 receives a notification confirming the update of the second root certificate group. Next, the process advances to S305, and the root certificate server 112 determines whether the root certificate signature and the root certificate name of the second root certificate group received from the information processing apparatus 100 match those of the updated new root certificate. This determination processing corresponds to processing of determining whether the root certificate server 112 can provide, to the information processing apparatus 100, the second root certificate group of a version newer than that of the second root certificate group held in the information processing apparatus 100. Determination that these pieces of information do not match each other corresponds to determination that the root certificate server 112 can provide, to the information processing apparatus 100, the second root certificate group of a version newer than that of the second root certificate group held in the information processing apparatus 100. Determination that the pieces of information match each other corresponds to determination that the root certificate server 112 cannot provide, to the information processing apparatus 100, the second root certificate group of a version newer than that of the second root certificate group held in the information processing apparatus 100. If it is determined in S305 that these pieces of information do not match, it is determined that it is necessary to update the second root certificate group saved in the information processing apparatus 100, and the process advances to S306. In S306, the root certificate server 112 creates an update necessity notification of the second root certificate group, and advances to S308. On the other hand, if it is determined in S305 that the pieces of information match each other, the root certificate server 112 determines that it is unnecessary to update the second root certificate group, and advances to S307 to create an update unnecessity notification of the second root certificate group. Then, the process advances to S308. In S308, the root certificate server 112 transmits the update necessity/unnecessity notification of the second root certificate group created in S306 or S307 to the information processing apparatus 100.

Thus, in S309, the information processing apparatus 100 receives, from the root certificate server 112, the notification indicating whether it is necessary or unnecessary to update the second root certificate group, and determines whether it is necessary to update the second root certificate group. If it is determined that it is necessary to update the second root certificate group, the process advances to S310; otherwise, the processing directly ends. In S310, the information processing apparatus 100 transmits, to the root certificate server 112, a request to acquire the second root certificate group.

Upon receiving the request to acquire the second root certificate group, the root certificate server 112 transmits, in S311, data of the updated second root certificate group to the information processing apparatus 100.

In S312, if the updated second root certificate group is received and the second root certificate group is stored in the RAM 103, the information processing apparatus 100 stores the received second root certificate group in the RAM 103 to overwrite and update the second root certificate group stored in the RAM 103. Alternatively, if the second root certificate group is not stored in the RAM 103 (the second root certificate group is stored only in the ROM 102), the information processing apparatus 100 stores the received second root certificate group in the RAM 103. After this processing, if communication with the content server 111 is started in a state in which the updated second root certificate group is stored in the RAM 103, the information processing apparatus 100 executes processing for executing encrypted communication with the content server 111. More specifically, the information processing apparatus 100 first acquires a server certificate corresponding to the content server 111 from the content server 111. Then, the information processing apparatus 100 verifies the server certificate using the second root certificate group deployed in the RAM 103. If the server certificate is successfully verified, the information processing apparatus 100 uses a public key existing in the server certificate to generate/acquire a common key to be used for encrypted communication with the content server 111. Then, the information processing apparatus 100 transmits the generated common key to the content server 111. The information processing apparatus 100 and the content server 111 communicate with each other by encrypted communication using the acquired common key. That is, by executing verification processing using the second root certificate group, the information processing apparatus 100 can execute encrypted communication with the content server 111.

The information processing apparatus 100 inquires of the root certificate server 112 whether the second root certificate group deployed in the RAM 103 has been updated. If the second root certificate group has been updated, the information processing apparatus 100 can acquire the updated second root certificate group from the root certificate server 112, and update the root certificate group in the RAM 103.

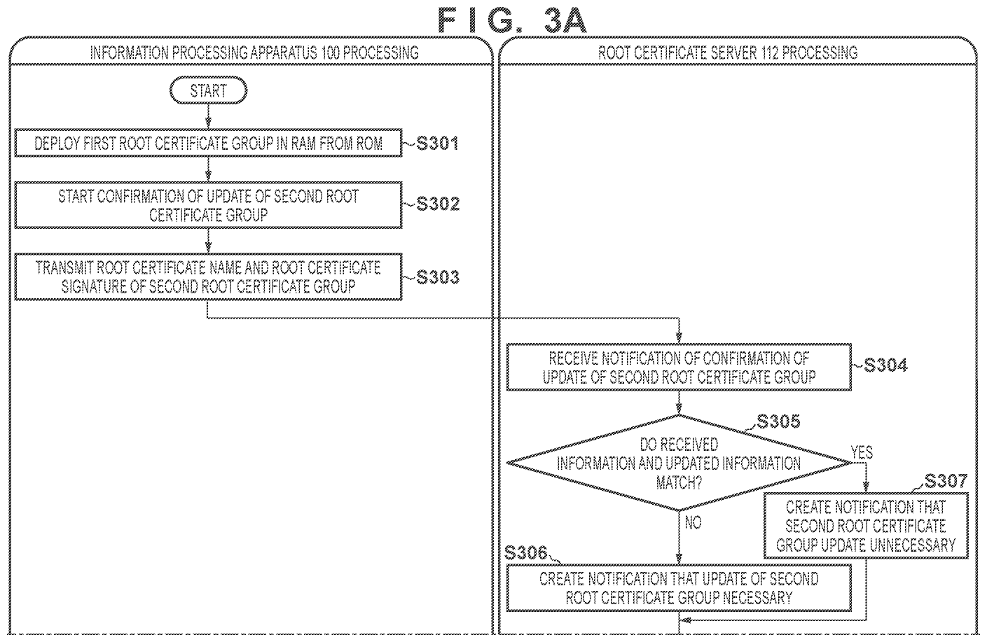

FIG. 4 is a view showing the relationship among the information processing apparatus 100, the root certificate server 112, and the content server 111 according to the first embodiment.

The information processing apparatus 100 communicates with various server apparatuses through a network via the Internet. Servers 111-A, 111-B, 111-C, and 111-D are content service servers, and are respectively set with server certificates issued by different certificate authorities (CAs) to perform encrypted communication.

The content service server 111-A is set with a server certificate (to be referred to as a company a server certificate hereinafter) issued by company a. The content service server 111-B is set with a server certificate (to be referred to as a company b server certificate hereinafter) issued by company b. The content service server 111-C is set with a server certificate (to be referred to as a company c server certificate hereinafter) issued by company c. The content service server 111-D is set with a server certificate (to be referred to as a company d server certificate hereinafter) issued by company d. Then, the root certificate server 112 is set with a server certificate (to be referred to as a company e server certificate hereinafter) issued by company e.

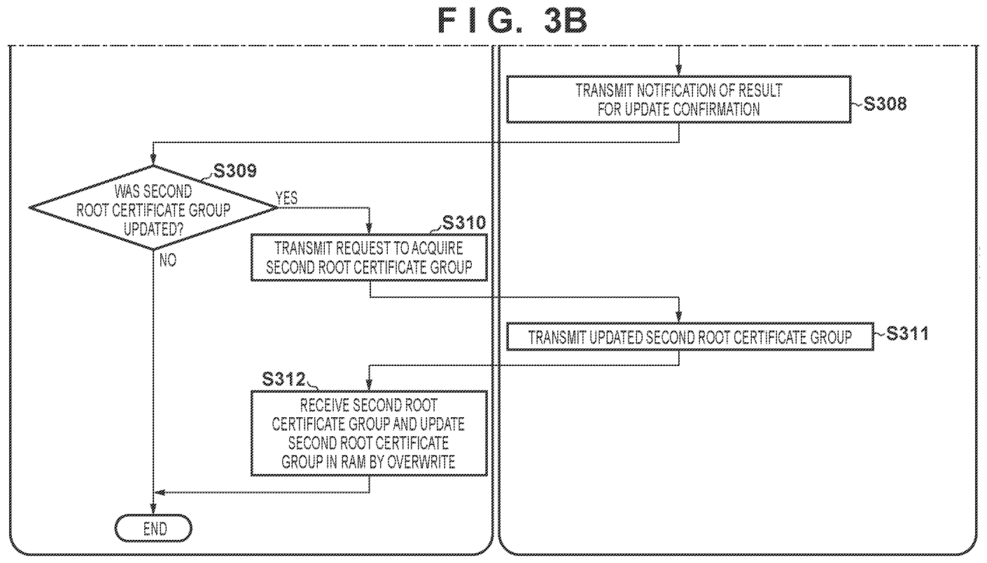

FIGS. 5A and 5B are views showing the data arrangements of the first root certificate group and the second root certificate group according to the first embodiment.

FIG. 5A shows the first root certificate group, in which a root certificate (to be referred to as a company e root certificate 501 hereinafter) issued by company e, that is necessary to perform encrypted communication with the root certificate server 112, is arranged. With this company e root certificate 501, it is possible to verify a server certificate issued by company e in encrypted communication with the root certificate server 112.

FIG. 5B shows the second root certificate group, in which a root certificate (to be referred to as a company a root certificate 502 hereinafter) issued by company a, that is necessary to perform encrypted communication with the content service server 111-A, is arranged. Furthermore, in the second root certificate group, a root certificate (to be referred to as a company b root certificate 503 hereinafter) issued by company b, that is necessary to perform encrypted communication with the content service server 111-B, is arranged. In the second root certificate group, a root certificate (to be referred to as a company c root certificate 504 hereinafter) issued by company c, that is necessary to perform encrypted communication with the content service server 111-C, is also arranged. In the second root certificate group, a root certificate (to be referred to as a company d root certificate 505 hereinafter) issued by company d, that is necessary to perform encrypted communication with the content service server 111-D, is also arranged. That is, each content service server is set with the server certificate issued by a different CA, and thus the root certificate of the different CA is used as the necessary root certificate.

The content service server 111-A is set with the company a server certificate, and the company a root certificate 502 corresponding to it is arranged in the second root certificate group. The content service server 111-B is set with the company b server certificate, and the company b root certificate 503 corresponding to it is arranged in the second root certificate group.

According to the first embodiment, there are provided the four server apparatuses for providing the content services, with which the information processing apparatus 100 performs communication. However, the number of content services may be larger than this, and the information processing apparatus 100 can communicate with more kinds of content service servers.

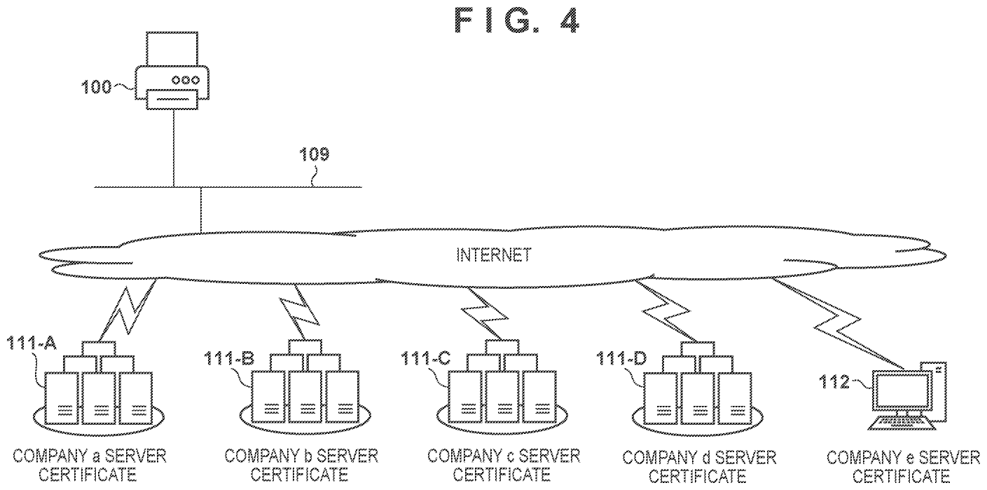

FIG. 6 is a view for explaining the states of the root certificates held in the ROM 102, the RAM 103, and the nonvolatile memory 113 in the information processing apparatus 100 according to the first embodiment.

The ROM 102 stores the first root certificate group and the second root certificate group. The two root certificate groups in the ROM 102 can be stored as data independent of firmware, or can be updated along with update of the firmware when incorporated in the firmware. Note that in the form in which the two root certificate groups are incorporated in the firmware, the two root certificate groups in the ROM 102 can be updated only by updating the firmware. In other words, only the two root certificate groups incorporated in the firmware cannot be updated separately from other components of the firmware. On the other hand, since it takes time to update the whole firmware, it is not preferable to update the whole firmware only to update the two root certificate groups. Therefore, in this embodiment, while maintaining the non-updated first root certificate group of the old version in the ROM 102, the updated first root certificate group of the new version is saved in the nonvolatile memory 113. If there exists the updated first root certificate group of the new version, the first root certificate group saved in the nonvolatile memory 113 is used for the processing for executing encrypted communication with the root certificate server 112. Furthermore, in this embodiment, while maintaining the non-updated second root certificate group of the old version in the ROM 102, the updated second root certificate group of the new version is saved in the RAM 103. If there exists the updated second root certificate group of the new version, the second root certificate group saved in the RAM 103 is used for the processing for executing encrypted communication with the content server 111. In this form, even if the root certificate group in the ROM 102 is incorporated in the firmware, the updated root certificate group of the new version can be used. Note that in this embodiment, at the time of arrival of the information processing apparatus 100, the first root certificate group and the second root certificate group have been stored in the ROM 102. Furthermore, as described above, at the time of arrival of the information processing apparatus 100, each root certificate group saved in the ROM 102 can be updated by updating the firmware. However, assume that a server that provides data for the update of the firmware is different from the root certificate server 112. That is, assume that the two root certificate groups stored in the ROM 102 are not those acquired from the root certificate server 112. In this embodiment, assume that the memory capacity of the nonvolatile memory 113 is smaller than that of the ROM 102 or the RAM 103. Assume also that the data capacity of the second root certificate group is larger than that of the first root certificate group. Therefore, since the second root certificate group cannot be fit in the nonvolatile memory 113, the second root certificate group is stored in the RAM 103. Note that the information stored in the RAM 103 is deleted when the information processing apparatus 100 is powered off. Therefore, if there exists the second root certificate group of a version newer than that of the second root certificate group stored in the ROM 102, the second root certificate group is acquired from the root certificate server 112 every time the information processing apparatus is powered on, and is stored in the RAM 103. On the other hand, the information stored in the nonvolatile memory 113 is not deleted even if the information processing apparatus 100 is powered off. Therefore, if there exists the first root certificate group of a version newer than that of the first root certificate group stored in the ROM 102 but the first root certificate group of the version is stored in the nonvolatile memory 113, the first root certificate group need not newly be acquired from the root certificate server 112 even when the information processing apparatus is powered on. As described above, the first root certificate group and the second root certificate group are deployed/stored in the RAM 103. Data stored in the ROM 102 is copied and used by a program at the time of activation of the information processing apparatus 100. However, if there is data acquired from the root certificate server 112, data in the RAM 103 is overwritten with the data and used by a program. The nonvolatile memory 113 stores the first root certificate group. If there is data acquired from the root certificate server 112, the data is stored in the nonvolatile memory 113 and used. In a case where the nonvolatile memory 113 stores the updated first root certificate group, the first root certificate group stored in the nonvolatile memory 113 is copied to the RAM 103 and used by a program without using the first root certificate group stored in the ROM 102. Furthermore, the nonvolatile memory 113 can store the second root certificate group. However, in a case where the number of content servers 111 is large, the size of the second root certificate group is also large, and thus the second root certificate group is not stored in the nonvolatile memory to prevent the necessary memory capacity of the expensive nonvolatile memory from increasing. Therefore, with respect to the second root certificate group, the copy of the data stored in the ROM 102 is used at the time of activation of the information processing apparatus 100, or if there is data acquired from the root certificate server 112, the data in the RAM 103 is overwritten with the data and used by a program.

As described above, according to the first embodiment, the ROM stores the first root certificate group and the second root certificate group, and the nonvolatile memory stores the first root certificate group. Then, if the first root certificate group is updated by the root certificate server, the updated first root certificate group is acquired from the root certificate server, and used to update the first root certificate group in the nonvolatile memory. If the second root certificate group is updated by the root certificate server, the updated second root certificate group is acquired from the root certificate server, and used to update the second root certificate group deployed in the RAM.

This can prevent the memory capacity of the expensive nonvolatile memory from increasing, and can cope with as an effect a case where the first root certificate group and the second root certificate group are updated.

### Second Embodiment

The above first embodiment has explained a case where a communication path with the root certificate server 112 is only encrypted communication. To the contrary, in the second embodiment, an arrangement of performing communication by non-encrypted communication in a case where encrypted communication is impossible in communication with a root certificate server 112 will be described with reference to a flowchart. A factor for making it impossible to perform encrypted communication is, for example, an expired root certificate or a change of a certificate authority of a server certificate. Note that the hardware arrangement of an information processing apparatus 100 and a system arrangement including a content server 111 and the root certificate server 112 according to the second embodiment are the same as in the above-described first embodiment and a description thereof will be omitted.

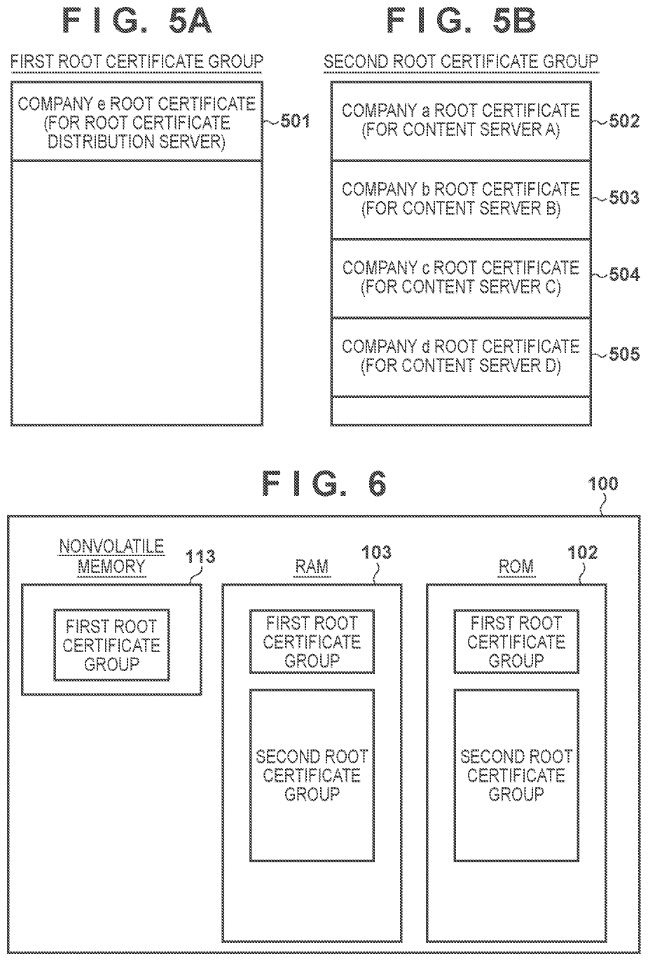

FIG. 7 is a flowchart for explaining processing in which an information processing apparatus 100 according to the second embodiment acquires a first root certificate group from the root certificate server 112. The first root certificate group stores one root certificate used for encrypted communication with the root certificate server 112 but can store a plurality of root certificates. Note that the processing shown in this flowchart is implemented when a CPU 101 executes a program deployed in a RAM 103.

In step S701, the CPU 101 determines whether the first root certificate group is stored in a nonvolatile memory 113. If it is determined in step S701 that the first root certificate group is stored in the nonvolatile memory 113, the process advances to step S702, and the CPU 101 deploys the first root certificate group stored in the nonvolatile memory 113 in the RAM 103. Then, the process advances to step S704. On the other hand, if it is determined in step S701 that the first root certificate group is not stored in the nonvolatile memory 113, the process advances to step S703, and the CPU 101 deploys the first root certificate group from a ROM 102 in the RAM 103. Then, the process advances to step S704. In step S704, the CPU 101 sets encrypted communication as a communication path, and advances to step S705.

In step S705, the CPU 101 starts confirmation of the update of the first root certificate group, and advances to step S706. In step S706, the CPU 101 transmits the root certificate signature and the root certificate name of the held first root certificate group data to the root certificate server 112. Then, the process advances to step S707, and the CPU 101 determines whether a notification of the result of confirming the update of the first root certificate group was received from the root certificate server 112. If it is determined in step S707 that the update confirmation result notification was not received, the process advances to step S708, and the CPU 101 determines whether the notification was not received by encrypted communication. If it is determined in step S708 that the notification was not received by encrypted communication, the process advances to step S709, and the CPU 101 sets non-encrypted communication as a communication path used for next communication, and returns to the processing in step S706. On the other hand, if it is determined in step S708 that the notification cannot be received by non-encrypted communication, the processing is completed without continuing the processing for receiving the first root certificate group from the root certificate server 112.

If it is determined in step S707 that the update confirmation result notification was received, the process advances to step S710, and the CPU 101 determines whether the first root certificate group has been updated. If it is determined in step S710 that the first root certificate group has not been updated, the processing ends. On the other hand, if it is determined in step S710 that the first root certificate group has been updated, the process advances to step S711, and the CPU 101 transmits, to the root certificate server 112, a request to acquire the first root certificate group. Then, the process advances to step S712, and the CPU 101 receives the first root certificate group from the root certificate server 112, and updates (overwrites) the first root certificate group in the nonvolatile memory 113, thereby ending the processing.

As described above, according to the second embodiment, if the first root certificate group is updated, the updated first root certificate group was received from the root certificate server and stored in the nonvolatile memory. If a notification indicating whether the first root certificate group has been updated is not received from the root certificate server, it is possible to switch communication to non-encrypted communication in a case of encrypted communication, and to attempt to receive an update confirmation result notification.

### Third Embodiment

As the third embodiment, an arrangement in which in a case where it is impossible to perform encrypted communication in communication with a root certificate server 112, a new root certificate is stored in a USB memory 115 and installed on an information processing apparatus 100 will be described next. A factor for making it impossible to perform encrypted communication is, for example, an expired root certificate or a change of a certificate authority of a server certificate. Note that the hardware arrangement of an information processing apparatus 100 and a system arrangement including a content server 111 and the root certificate server 112 according to the third embodiment are the same as in the above-described first embodiment and a description thereof will be omitted.

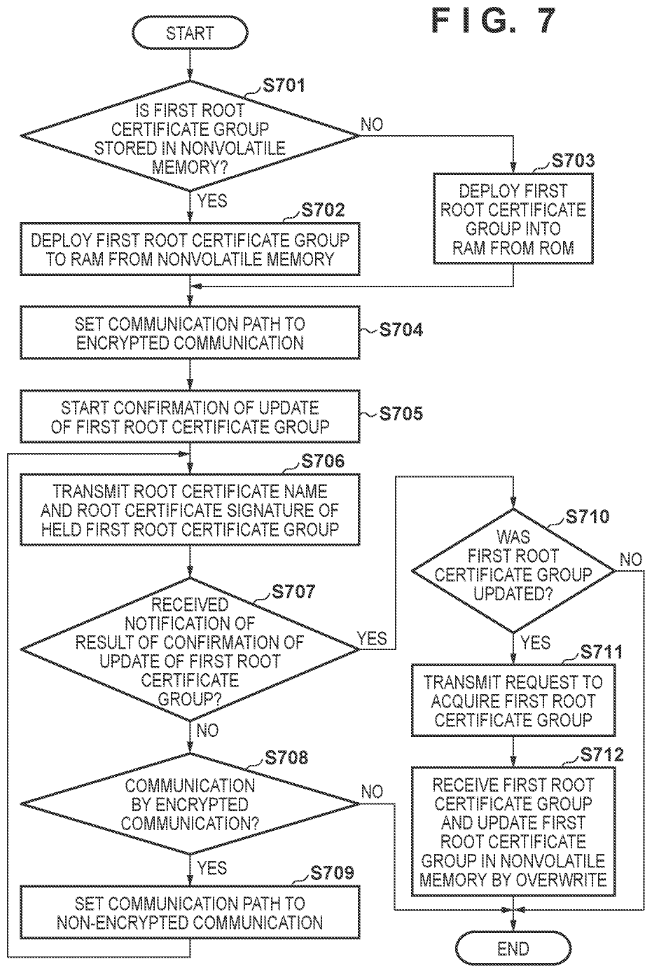

FIG. 8 is a flowchart for explaining processing in which the information processing apparatus 100 according to the third embodiment acquires a first root certificate group from the root certificate server 112. The first root certificate group stores one root certificate used for encrypted communication with the root certificate server 112 but can store a plurality of root certificates. Note that the processing shown in this flowchart is implemented when a CPU 101 executes a program deployed in a RAM 103.

In step S801, the CPU 101 determines whether the first root certificate group is stored in a nonvolatile memory 113. If it is determined in step S801 that the first root certificate group is stored in the nonvolatile memory 113, the process advances to step S802, and the CPU 101 deploys the first root certificate group stored in the nonvolatile memory 113 in the RAM 103. Then, the process advances to step S804. On the other hand, if it is determined in step S801 that the first root certificate group is not stored in the nonvolatile memory 113, the process advances to step S803, and the CPU 101 deploys the first root certificate group from a ROM 102 in the RAM 103. Then, the process advances to step S804. In step S804, the CPU 101 starts confirmation of the update of the first root certificate group.

In step S805, the CPU 101 transmits the root certificate signature and the root certificate name of the held first root certificate group data to the root certificate server 112. Next, the process advances to step S806, and the CPU 101 determines whether a notification of the result of confirming the update of the first root certificate group was received from the root certificate server 112. If it is determined in step S806 that the update confirmation result notification was not received, the process advances to step S807, and the CPU 101 determines whether the root certificate in the first root certificate group has expired. If it is determined in step S807 that root certificate has expired, the process advances to step S808, and the CPU 101 displays, on an operation unit 107, the fact that the root certificate has expired. Then, the process advances to step S809. In step S809, the CPU 101 displays an instruction to install the root certificate using the USB memory 115 to update the root certificate, thereby ending the processing. On the other hand, if it is determined in step S807 that the root certificate has not expired, the process advances to step S809, and the CPU 101 displays an instruction to install the root certificate using the USB memory 115 to update the root certificate, thereby ending the processing.

If it is determined in step S806 that the update confirmation result notification can be received from the root certificate server 112, the process advances to step S810, and the CPU 101 determines whether the first root certificate group has been updated. If it is determined in step S810 that the first root certificate group has not been updated, the CPU 101 ends the processing. If it is determined in step S810 that the first root certificate group has been updated, the process advances to step S811, and the CPU 101 transmits, to the root certificate server 112, a request to acquire the first root certificate group. Then, the process advances to step S812, and the CPU 101 receives the first root certificate group from the root certificate server 112, and updates (overwrites) the first root certificate group in the nonvolatile memory 113, thereby ending the processing.

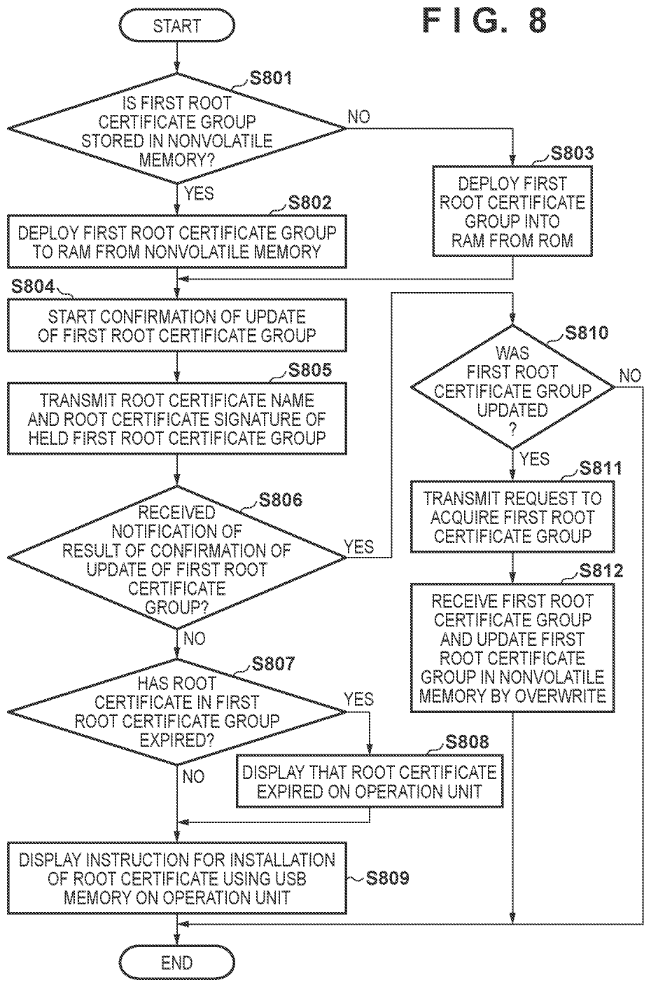

FIG. 9 is a view showing an example of a screen for displaying, in step S808 of FIG. 8, on the operation unit 107 of the information processing apparatus 100, the fact that the root certificate has expired.

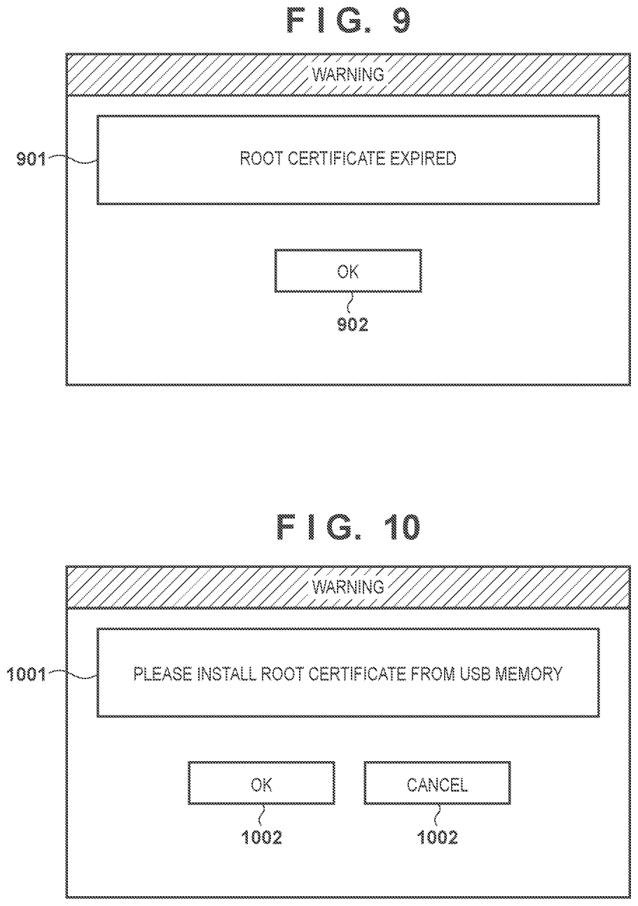

On this screen, a warning message 901 indicating that the root certificate has expired and an OK button 902 are displayed. When the OK button 902 is pressed, the screen transitions to a screen shown in FIG. 10.

FIG. 10 is a view showing an example of a screen for displaying, in step S809 of FIG. 8, an instruction to install the root certificate using the USB memory 115 to update the root certificate.

On this screen, a message 1001 for prompting the user to install the root certificate from the USB memory, an OK button 1002, and a cancel button 1003 are displayed. When the user installs the root certificate from the USB memory, he/she presses the OK button 1002. This installs the root certificate from the USB memory 115 via the USB I/F 114, and stores it in the nonvolatile memory 113. On the other hand, when the user does not install the root certificate from the USB memory, he/she presses the cancel button 1003. Upon the pressing of the cancel button 1003, the processing ends without installing the root certificate from the USB memory 115.

As described above, according to the third embodiment, the information processing apparatus inquires of the root certificate server whether the first root certificate group has been updated. If a response to it is not received, the information processing apparatus determines whether the first root certificate group is expired. If the first root certificate group is expired, a warning message and a screen for selecting whether to install the root certificate from the USB memory are displayed. In accordance with a selection on the screen, it is possible to instruct to load the first root certificate group from the USB memory.

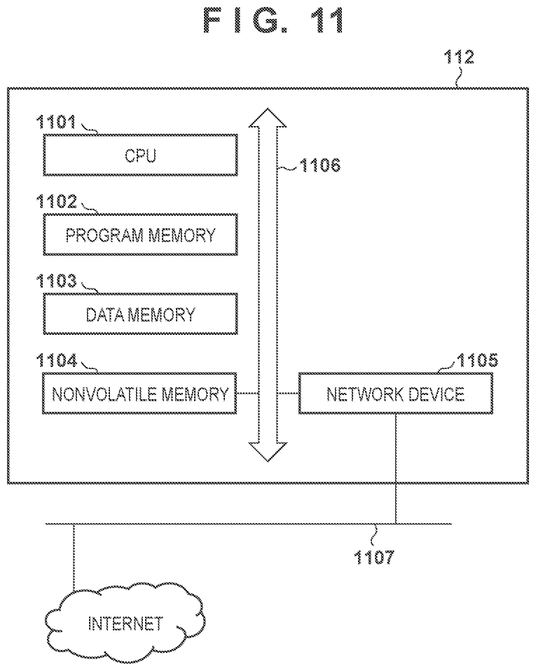

FIG. 11 is a block diagram showing the hardware arrangement of a root certificate server 112 according to an embodiment.

The root certificate server 112 includes a CPU 1101, a program memory 1102, a data memory 1103, a nonvolatile memory 1104, and a network device 1105. These are connected to the CPU 1101 via an internal bus 1106. The CPU 1101 controls the respective units via the internal bus 1106 by executing programs in the program memory. The network device 1105 is connected to the Internet via a network 1107.

### Other Embodiments

Note that the form in which the two root certificate groups are saved in advance in the ROM 102 and, in a case where the root certificate server 112 can provide a root certificate newer than the root certificate group saved in the ROM 102, the new root certificate is acquired from the root certificate server 112 has been explained above. However, the present invention is not limited to this. That is, the two root certificate groups need not be saved in advance in the ROM 102. Then, a new root certificate may be acquired from the root certificate server 112 without performing comparison with the root certificate group saved in the ROM 102 every time the information processing apparatus 100 is powered on or every time it is necessary to perform communication with the content server 111.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2023-023635, filed Feb. 17, 2023, and No. 2024-013310, filed Jan. 31, 2024 which are hereby incorporated by reference herein in their entirety.

1. An information processing apparatus comprising at least one memory and at least one processor which function as:
a first acquisition unit configured to acquire a first root certificate for executing encrypted communication with a first server from the first server;
a second acquisition unit configured to acquire, via encrypted communication that is executable by using the first root certificate, a second root certificate for executing encrypted communication with a second server different from the first server; and
a communication unit configured to communicate with the second server via encrypted communication that is executable by using the second root certificate.

2. The apparatus according to claim 1, wherein in a case where the first server can provide the first root certificate of a version newer than a version of the first root certificate held in the information processing apparatus, the first root certificate is acquired from the first server.

3. The apparatus according to claim 1, wherein
in a case where the first server can provide the first root certificate of a version newer than a version of the first root certificate saved in a first memory of the information processing apparatus, the first root certificate is acquired from the first server, and
the first root certificate acquired from the first server is saved in a second memory that is a memory different from the first memory and is a memory of the information processing apparatus.

4. The apparatus according to claim 3, wherein the first root certificate acquired from the first server is saved in the second memory while being saved in the first memory.

5. The apparatus according to claim 3, wherein
the first memory is a ROM, and
the second memory is a nonvolatile memory.

6. The apparatus according to claim 3, wherein the first root certificate saved in the first memory of the information processing apparatus is incorporated in firmware of the information processing apparatus.

7. The apparatus according to claim 3, wherein the first root certificate saved in the first memory of the information processing apparatus is updated by firmware of the information processing apparatus.

8. The apparatus according to claim 3, wherein
in a case where the first server can provide the second root certificate of a version newer than a version of the second root certificate saved in the first memory, the second root certificate is acquired from the first server, and
the second root certificate acquired from the first server is saved in a third memory that is a memory different from the first memory and the second memory and is a memory of the information processing apparatus.

9. The apparatus according to claim 8, wherein
the first memory is a ROM, and
the third memory is a RAM.

10. The apparatus according to claim 8, wherein a data capacity of the second root certificate is larger than a memory capacity of the second memory.

11. The apparatus according to claim 8, wherein
in a case where the first server can provide the second root certificate of a version newer than the version of the second root certificate saved in the third memory, the second root certificate is acquired from the first server, and
the second root certificate acquired from the first server is saved in the third memory to update the second root certificate saved in the third memory.

12. The apparatus according to claim 1, wherein the first root certificate is acquired from the first server based on power-on of the information processing apparatus.

13. The apparatus according to claim 1, wherein the second root certificate is acquired from the first server based on at least one of power-on of the information processing apparatus and execution of a predetermined operation for communication with the second server in the information processing apparatus.

14. The apparatus according to claim 1, wherein the second root certificate is acquired from the first server after the first root certificate is acquired from the first server.

15. The apparatus according to claim 1, wherein the second root certificate includes a root certificate for executing encrypted communication with the second server, and a root certificate for executing encrypted communication with a third server different from the first server and the second server.

16. The apparatus according to claim 1, wherein the first root certificate is acquired from the first server by communication different from encrypted communication.

17. The apparatus according to claim 1, further comprising a print unit configured to execute printing.

18. The apparatus according to claim 17, wherein printing is executed based on information acquired from the second server via encrypted communication that is executable by using the second root certificate.

19. A method executed by an information processing apparatus, the method comprising:
acquiring a first root certificate for executing encrypted communication with a first server from the first server;
acquiring, via encrypted communication that is executable by using the first root certificate, a second root certificate for executing encrypted communication with a second server different from the first server; and
communicating with the second server via encrypted communication that is executable by using the second root certificate.

20. A non-transitory computer-readable storage medium storing a program configured to cause a computer to function to:
acquire a first root certificate for executing encrypted communication with a first server from the first server;
acquire, via encrypted communication that is executable by using the first root certificate, a second root certificate for executing encrypted communication with a second server different from the first server; and
communicate with the second server via encrypted communication that is executable by using the second root certificate.
